(19) United States
(12) Patent Application Publication
(10) Pub. No.: US 2014/0160413 A1
(43) Pub. Date: Jun. 12, 2014

(54) ELECTRO-OPTICAL DEVICE AND ELECTRONIC APPARATUS

(71) Applicant: SEIKO EPSON CORPORATION, Tokyo (JP)

(72) Inventor: Masakazu Nishida, Chino-shi (JP)

(73) Assignee: SEIKO EPSON CORPORATION, Tokyo (JP)

(21) Appl. No.: 14/098,368

(22) Filed: Dec. 5, 2013

(30) Foreign Application Priority Data
Dec. 7, 2012 (JP) 2012-267974

(51) Int. Cl. G02F 1/1337

(52) U.S. Cl. CPC G02F 1/133707
USPC 349/123

(57) ABSTRACT

An electro-optical device includes a first substrate, a second substrate and a liquid crystal, and has a display region and a peripheral region. The peripheral region of the first substrate has a peripheral electrode and a first orientation film covering the peripheral electrode. Then, since the density of first orientation film in the display region is different from the density of the first orientation film in the peripheral region, it is possible to efficiently capture ionic impurities present in the liquid crystal.

### BACKGROUND

1. Technical Field

The present invention relates to, for example, an electro-optical device and an electronic apparatus.

2. Related Art

A projector is an electronic apparatus which radiates light to a transmissive type electro-optical device or a reflective type electro-optical device and projects transmitted light or reflected light which is modulated by those electro-optical devices onto a screen. The projector is configured such that the light emitted from a light source is condensed and incident on the electro-optical device, and the transmitted light or the reflected light which is modulated depending on an electric signal is projected to be magnified onto the screen through a projection lens. The projector has an advantage of displaying a large screen. A liquid crystal device is known as the electro-optical device used in such an electronic apparatus and forms an image using dielectric anisotropy of the liquid crystal and optical rotation of light. In such a liquid crystal device, it is known that ionic impurities which are mixed into a liquid crystal material in a manufacturing process or ionic impurities which are generated by degradation of members due to light radiation or the like cause a decrease in display quality. For example, in a region where concentration of the ionic impurities is high, a decrease in luminance or the like occurs and irregularity or a stain is visible.

Since it is difficult not to mix ionic impurities at all into the display region in the manufacturing process, a technique is proposed in which diffusion of the ionic impurities into the display region is suppressed by adsorbing the ionic impurities in an electrode provided in a non-display region, as disclosed in JP-A-11-38389 and JP-A-2000-338510. Furthermore, in JP-A-2007-249105, retention and adsorption of the ionic impurities are increased by providing a layer of a porous material having low thermal conductivity on the electrode adsorbing the ionic impurities for capturing the ionic impurities and thus a decrease in a voltage applied to the electrode adsorbing the ionic impurities is suppressed.

However, in a liquid crystal device disclosed in JP-A-11-38389 or JP-A-2000-338510, there is a problem that it is necessary for a high voltage to be continuously applied to the liquid crystal material for capturing the ionic impurities and temporal degradation is caused in the liquid crystal material. In addition, continuously applying a high voltage to the liquid crystal material causes generation of new impurities and promotion of the temporal degradation of the liquid crystal material in an accelerated manner. That is, in the liquid crystal device disclosed in JP-A-11-38389 or JP-A-2000-338510, there is a problem that a decrease in the display quality cannot be avoided and product life of the liquid crystal device is limited. On the other hand, in the configuration disclosed in JP-A-2007-249105, there is a problem that even though the decrease in the applied voltage can be suppressed, it is necessary to deposit a special material on the electrode and the manufacturing process is complicated. As described above, in the liquid crystal device of the related art, there is a problem that it is difficult to achieve both a product life of the liquid crystal device and a simple manufacturing process thereof.

### SUMMARY

The invention can be realized in the following forms or application examples.

### Application Example 1

According to this application example, there is provided an electro-optical device including: a first substrate; a second substrate disposed opposite to the first substrate; and an electro-optical material which is sandwiched between the first substrate and the second substrate in a display region and a peripheral region provided outside the display region, in which the first substrate has a switching element provided in the display region and a pixel electrode electrically connected to the switching element; a peripheral electrode provided in the peripheral region; and a first orientation film provided between the pixel electrode, the peripheral electrode and the electro-optical material, in which the second substrate has a common electrode; and a second orientation film provided between the common electrode and the electro-optical material, and in which the density of the first orientation film formed in the display region is different from the density of the first orientation film formed in the peripheral region or the density of the second orientation film formed in the display region is different from the density of the second orientation film formed in the peripheral region.

In the electro-optical device (liquid crystal device) using the liquid crystal as the electro-optical material, the first orientation film and the second orientation film formed in the display region are made of a homogeneous material, an electric symmetry is maintained between the substrates, and temporal degradation of the display quality is prevented. Therefore, in this case, the density of the first orientation film formed in the peripheral region is different from the density of the second orientation film formed in the peripheral region and an electric asymmetry is maintained in the peripheral region. Therefore, since an unusual electric field is formed between the first substrate and the second substrate, it is possible to efficiently capture ionic impurities present in the liquid crystal. That is, display defects such as irregularity or stain are reduced and high display quality is obtained, and it is possible to prevent a decrease in the high display quality of the liquid crystal device which is manufactured in a simple manufacturing process thereof without it being necessary to continuously apply a high voltage to the liquid crystal material. In other words, it is possible to achieve both a product life of the liquid crystal device and a simple manufacturing process thereof.

### Application Example 2

In the electro-optical device according to the application example, the density of the first orientation film formed in the peripheral region is preferably different from the density of the second orientation film formed in the peripheral region.

In this case, since an electric asymmetry is maintained in the peripheral region and an unusual electric field is formed between the first substrate and the second substrate, it is possible to efficiently capture the ionic impurities present in the liquid crystal. That is, it is possible to suppress the decrease in the high display quality of the liquid crystal device manufactured in a simple manufacturing process without it being necessary to continuously apply a large voltage to the liquid crystal material. In other words, it is possible to achieve both the product life of the liquid crystal device and the simple manufacturing process thereof.

### Application Example 3

In the electro-optical device according to the application example, the density of the first orientation film formed in the display region is preferably substantially the same as the density of the second orientation film formed in the display region.

In this case, since the first orientation film and the second orientation film formed in the display region are made of the homogeneous material, it is possible to maintain the electric symmetry between the substrates and to prevent the temporal degradation of the display quality. Furthermore, since the density of the first orientation film formed in the peripheral region is different from the density of the second orientation film formed in the peripheral region, the electric asymmetry is maintained in the peripheral region. Therefore, the unusual electric field is formed between the first substrate and the second substrate, and it is possible to efficiently capture the ionic impurities present in the liquid crystal. That is, it is possible to decrease display defects such as irregularity or a stain to obtain high display quality, and it is possible to suppress the decrease in the high display quality of the liquid crystal device manufactured in a simple manufacturing process without it being necessary to continuously apply a large voltage to the liquid crystal material. In other words, it is possible to achieve both the product life of the liquid crystal device and the simple manufacturing process thereof.

### Application Example 4

In the electro-optical device according to the application example, the density of the first orientation film formed in the display region, the density of the second orientation film formed in the display region and the density of the second orientation film formed in the peripheral region are preferably substantially the same as each other, and the density of the first orientation film formed in the display region is preferably different from the density of first orientation film formed in the peripheral region.

In this case, since the first orientation film and the second orientation film formed in the display region are made of the homogeneous material, it is possible to maintain the electric symmetry between the substrates and to prevent the temporal degradation of the display quality. Furthermore, since the density of the first orientation film formed in the peripheral region is different from the density of the second orientation film formed in the peripheral region, the electric asymmetry is maintained in the peripheral region. Therefore, the unusual electric field is formed between the first substrate and the second substrate, and it is possible to efficiently capture the ionic impurities present in the liquid crystal. That is, it is possible to decrease display defects such as irregularity or stain to obtain high display quality, and it is possible to suppress the decrease in the high display quality of the liquid crystal device manufactured using the simple manufacturing process without it being necessary to continuously apply a large voltage to the liquid crystal material. In other words, it is possible to achieve both the product life of the liquid crystal device and the simple manufacturing process thereof.

### Application Example 5

In the electro-optical device according to the application example, the density of the first orientation film formed in the display region, the density of the second orientation film formed in the display region and the density of the first orientation film formed in the peripheral region are preferably substantially the same as each other, and the density of the second orientation film formed in the display region is preferably different from the density of the second orientation film formed in the peripheral region.

In this case, since the first orientation film and the second orientation film formed in the display region are made of the homogeneous material, it is possible to maintain the electric symmetry between the substrates and to prevent the temporal degradation of the display quality. Furthermore, since the density of the first orientation film formed in the peripheral region is different from the density of the second orientation film formed in the peripheral region, the electric asymmetry is maintained in the peripheral region. Therefore, the unusual electric field is formed between the first substrate and the second substrate, and it is possible to efficiently capture the ionic impurities present in the liquid crystal. That is, it is possible to decrease display defects such as irregularity or stain to obtain high display quality, and it is possible to suppress the decrease in the high display quality of the liquid crystal device manufactured using the simple manufacturing process without it being necessary to continuously apply a large voltage to the liquid crystal material. In other words, it is possible to achieve both the product life of the liquid crystal device and the simple manufacturing process thereof.

### Application Example 6

In the electro-optical device according to the application example, the density of the first orientation film formed in the display region is preferably substantially the same as the density of the second orientation film formed in the display region, the density of the first orientation film formed in the peripheral region is preferably different from the density of the second orientation film formed in the peripheral region, the density of the first orientation film formed in the display region is preferably different from the density of the first orientation film formed in the peripheral region, and the density of the second orientation film formed in the display region is preferably different from the density of the second orientation film formed in the peripheral region.

In this case, since the first orientation film and the second orientation film formed in the display region are made of the homogeneous material, it is possible to maintain the electric symmetry between the substrates and to prevent the temporal degradation of the display quality. Furthermore, since the density of the first orientation film formed in the peripheral region can be different from the density of the second orientation film formed in the peripheral region, the electric asymmetry can be maintained in the peripheral region. Therefore, the unusual electric field is formed between the first substrate and the second substrate, and it is possible to efficiently capture the ionic impurities present in the liquid crystal. That is, it is possible to decrease display defects such as irregularity or stain to obtain high display quality, and it is possible to suppress the decrease in the high display quality of the liquid crystal device manufactured in the simple manufacturing process without it being necessary to continuously apply a large voltage to the liquid crystal material. In other words, it is possible to achieve both the product life of the liquid crystal device and the simple manufacturing process thereof.

### Application Example 7

According to this application example, there is provided an electronic apparatus including the electro-optical device according to any one of the above application examples.

In this case, it is possible to manufacture the electronic apparatus having the long product life with a relatively simple manufacturing process.

### BRIEF DESCRIPTION OF THE DRAWINGS

The invention will be described with reference to the accompanying drawings, wherein like numbers reference like elements.

FIG. 1 is a plan view describing a configuration of a liquid crystal device.

FIG. 2 is a partial cross-sectional view of the liquid crystal device in a position taken along line II-II illustrated in FIG. 1.

FIG. 3 is a schematic enlarged cross-sectional view of the liquid crystal device.

FIG. 4 is a view describing a principle of ion capture.

FIG. 5 is a schematic view illustrating a configuration of a projection type display device as an electronic apparatus.

FIG. 6 is a schematic enlarged cross-sectional view of a liquid crystal device.

FIG. 7 is a schematic enlarged cross-sectional view of a liquid crystal device.

FIG. 8 is a schematic enlarged cross-sectional view of a liquid crystal device.

FIG. 9 is a schematic enlarged cross-sectional view of a liquid crystal device.

FIG. 10 is a schematic enlarged cross-sectional view of a liquid crystal device.

FIG. 11 is a schematic enlarged cross-sectional view of a liquid crystal device.

FIG. 12 is a schematic enlarged cross-sectional view of a liquid crystal device.

### DESCRIPTION OF EXEMPLARY EMBODIMENTS

Hereinafter, embodiments of the invention will be described with reference to the drawings. In addition, scale of each layer or each member is different from an actual size thereof so that each layer or each element can be a recognizable size in the drawings described below.

### Embodiment 1

### Overview of Electro-Optical Device

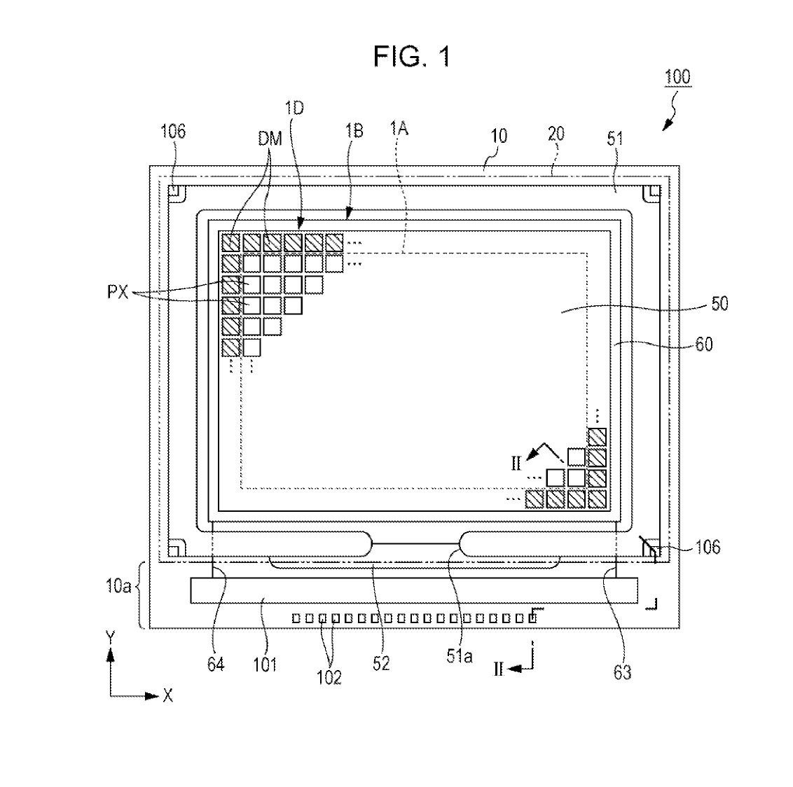

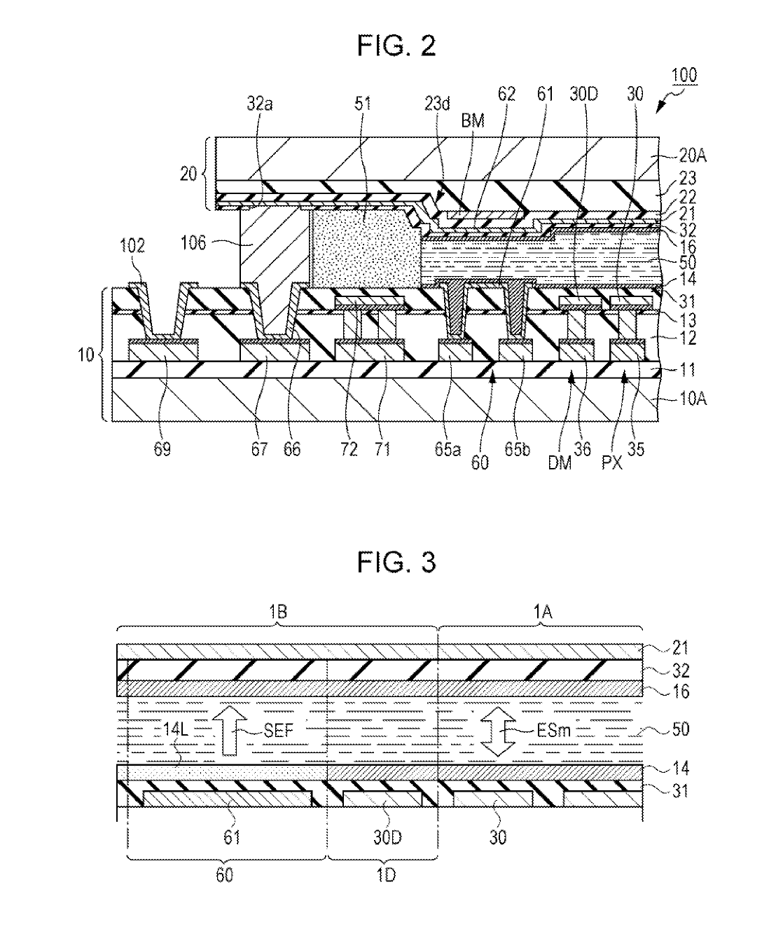

FIG. 1 is a plan view describing a configuration of a liquid crystal device. FIG. 2 is a partial cross-sectional view of the liquid crystal device in a position taken along line II-II illustrated in FIG. 1. First, a summary of an electro-optical device will be described with reference to FIGS. 1 and 2. In the embodiment, the electro-optical device is a reflective type liquid crystal device 100 and the liquid crystal device 100 includes a Thin Film Transistor (TFT) as the switching element of pixels. Furthermore, in the views which are referred to in the following description, an upper layer side or a surface side means a side (side on which an opposite substrate is positioned) opposite to a side on which a substrate body of an element substrate is positioned and a lower layer side means a side on which the substrate body of the element substrate is positioned, when describing a layer formed on the element substrate. In addition, an upper layer side or a surface side means a side (side on which the element substrate is positioned) opposite to a side on which a substrate body of the opposite substrate is positioned and a lower layer side means a side on which the substrate body of the opposite substrate is positioned, when describing a layer formed on the opposite substrate.

As illustrated in FIGS. 1 and 2, the electro-optical device (the liquid crystal device 100) includes a first substrate (an element substrate 10), a transparent second substrate (an opposite substrate 20) which is disposed opposite to the first substrate, an electro-optical material (a liquid crystal material 50) which is interposed between the first substrate and the second substrate, a rectangular frame-shaped seal material 51 which is formed to surround a periphery of the liquid crystal material 50 and has a liquid crystal injection port 51a, and a sealant 52 for sealing the liquid crystal injection port 51a of the seal material 51.

The opposite substrate 20 having a contour substantially the same as an outer edge of the seal material 51 is disposed opposite to the element substrate 10 on the element substrate 10. The element substrate 10 and the opposite substrate 20 are bonded through the seal material 51. The element substrate 10 is larger than the opposite substrate 20 and includes an extended section 10a which is extended outside from one end section of the opposite substrate 20. The extended section 10a has a driving IC chip 101 and a terminal section in which a plurality of external circuit connection terminals 102 are formed. Hereinafter, a direction along an upper side and lower side is referred to as X-direction and a direction along a right side and left side is referred to as Y-direction in FIG. 1.

The seal material 51 is provided along a peripheral section of a region where the element substrate 10 and the opposite substrate 20 are opposite to each other. The liquid crystal injection port 51a is provided on a side facing the extended section 10a of four sides of the seal material 51. The sealant 52 is applied at a position where the liquid crystal injection port 51a of the extended section 10a is closed from the outside along an end surface of the opposite substrate 20. The seal material 51 and the sealant 52 surround the periphery of the liquid crystal material 50 and seal the liquid crystal material 50 between the element substrate 10 and the opposite substrate 20. In other words, the liquid crystal material 50 is sealed in a region surrounded by the seal material 51. The liquid crystal material 50 has a negative dielectric anisotropy. For example, as the seal material 51, an adhesive such as a heat curable or ultraviolet curable epoxy resin or the like is employed. A spacer (not illustrated) for constantly maintaining an interval between the element substrate 10 and the opposite substrate 20 is mixed in the seal material 51. As a sealing method (filling method) of the liquid crystal between the element substrate 10 and the opposite substrate 20, a One Drop Fill method (ODF method) may be used in addition to the embodiment. The ODF method is a method in which the seal material 51 is disposed in a frame shape along the outer periphery of one side substrate (for example, the element substrate 10), the disposed seal material 51 is provided as a bank, the liquid crystal of a predetermined amount is dripped inside thereof and then one side substrate and the other side substrate are bonded each other under reduced pressure.

A rectangular display region 1A in which a plurality of pixels PX are disposed in a matrix shape and a rectangular frame-shaped peripheral region 1B positioned between the display region 1A and the seal material 51 are provided in a region surrounded by the seal material 51. That is, the electro-optical device has the display region 1A and the peripheral region 1B outside the display region 1A, and a region other than the display region 1A is the peripheral region 1B in the electro-optical device. Furthermore, the peripheral region 1B does not necessarily surround the display region 1A and, for example, one side of the display region 1A matches with the seal material 51 and then the peripheral region 1B may be provided on other three sides of the display region 1A. An inter-substrate conductive section 106 having a silver point for electrically connecting between the element substrate 10 and the opposite substrate 20 is provided in a corner section of the opposite substrate 20 on the outside of the seal material 51.

The plurality of matrix-shaped pixels PX are disposed in the display region 1A. A pixel electrode 30 (see FIG. 2) which is electrically connected to the switching element (TFT) is formed on the first substrate. In contrast, the peripheral region 1B has a rectangular frame-shaped dummy section 1D surrounding the display region 1A and a rectangular frame-shaped ion trap section 60 provided outside the dummy section 1D.

The dummy section 1D has the pixels PX which are positioned in the outermost peripheral section of the display region 1A and a plurality of dummy pixels DM which are adjacent to each other. A first potential is supplied to the dummy pixels DM. In a word, the display region 1A is a region where a plurality of pixels PX and various images can be displayed. Meanwhile, the dummy section 1D is a region where the plurality of dummy pixels DM are disposed and display of a certain gradation is performed on the entire dummy section 1D. In the embodiment, the first potential is supplied to the dummy section 1D so as to perform a dark display (black display).

In the embodiment, the ion trap section 60 is disposed to surround the display region 1A. In FIG. 1, in order to efficiently capture ionic impurities which diffuse toward the peripheral region 1B from the display region 1A and ionic impurities which elute from the seal material 51 and penetrate the display region 1A, the ion trap section 60 is formed as a whole in a closed frame shape along the outer periphery of the display region 1A. However, the ion trap section 60 may not necessarily be the rectangular frame-shape surrounding the display region 1A and may be various forms which are linearly formed along a part of the outside of the display region 1A depending on circumstances in a layout in addition to the rectangular frame-shape. Furthermore, in FIG. 1, in order to facilitate understanding of the description, total pixels PX or the dummy pixels DM are not drawn and a part thereof is drawn.

Next, a cross-sectional structure of the liquid crystal device 100 will be described with reference to FIG. 2. For example, the element substrate 10 is a substrate where the pixel electrode 30, a dummy electrode 30D, a peripheral electrode 61, a driving element (not illustrated) driving the electrodes or the like is formed on a substrate body 10A of a transparent quartz glass, an alkali-free glass, an opaque silicon substrate or the like. On the other hand, for example, the opposite substrate 20 includes a common electrode 21 or the like on a substrate body 20A of the transparent quartz glass, the alkali-free glass, or the like. The liquid crystal material 50 is disposed between the element substrate 10 and the opposite substrate 20.

As illustrated in FIG. 2, the ion trap section 60 includes the peripheral electrode 61 formed on the substrate body 10A of the element substrate 10. That is, the peripheral electrode 61 is formed on the ion trap section 60 of the first substrate. The ion trap section 60 captures the ionic impurities in the liquid crystal material 50 by an electric field generated between the peripheral electrode 61 and the common electrode 21 in the thickness direction. Furthermore, in the embodiment, the common electrode 21 (a portion facing the peripheral electrode 61 through the liquid crystal material 50 in the common electrode 21) of the ion trap section 60 may be referred to as a second peripheral electrode 62. A peripheral electrode signal V11 is supplied to the peripheral electrode 61 so that the ion trap section 60 effectively captures the ionic impurities. A common potential V_{com} is supplied to the common electrode 21. Furthermore, in the embodiment, the peripheral electrode 61 is a rectangular frame-shaped electrode surrounding the display region 1A; however, the peripheral electrode 61 may be various forms which are linearly formed along a part of the outside of the display region 1A in a plan view in addition to the rectangular frame-shape. As illustrated in FIG. 1, the peripheral electrode 61 is connected to the driving IC chip 101 through lead lines 63 and 64 extending across the seal material 51.

An underlying insulation film 11 made of a silicon oxide film or the like is formed on a surface of the substrate body 10A on a liquid crystal material 50 side. A plurality of types of wirings 35, 36, 65a, 65b, 67, 69 and 71 are formed on the underlying insulation film 11. A first inter-layer insulation film 12 made of the silicon oxide film or the like is formed to cover the wirings and a second inter-layer insulation film 13 made of a silicon nitride film or the like is formed to cover the first inter-layer insulation film 12.

The pixel electrode 30, the dummy electrode 30D and a wiring 72 are formed on the second inter-layer insulation film 13. The pixel electrode 30 and the dummy electrode 30D are connected to the wirings 35 and 36 of the lower layer side through contact holes formed by penetrating the first inter-layer insulation film 12 and the second inter-layer insulation film 13. In the embodiment, the pixel electrode 30 and the dummy electrode 30D are composed of a conductive reflective film made of a laminated film obtained by forming an aluminum film on a titanium nitride film. Furthermore, when the liquid crystal device 100 is configured as a transmissive type liquid crystal device, the pixel electrode 30 and the dummy electrode 30D are formed using a transparent conductive material such as indium tin oxide (ITO).

The wiring 72 is connected to the wiring 71 of the lower layer side through contact holes formed by penetrating the first inter-layer insulation film 12 and the second inter-layer insulation film 13. The wiring 71 and the wiring 72 are wirings connecting between pixels PX or the dummy pixels DM formed inside the seal material 51 and the driving IC chip 101 outside the seal material 51. In the embodiment, the wirings 71 and 72 formed in different wiring layers are connected to each other in a region for forming the seal material 51.

A third insulation film 31 is formed to cover the pixel electrode 30, the dummy electrode 30D and the wiring 72. The third insulation film 31 is formed using a material having a high resistance of double digits or more relative to a resistance value of the liquid crystal material 50 and, for example, is made of the silicon oxide film or the silicon nitride film. The peripheral electrode 61, a conductive section electrode 66 and the external circuit connection terminals 102 are formed on the third insulation film 31.

The peripheral electrode 61 is connected to the wirings 65a and 65b of the lower layer side through contact holes formed by penetrating the first inter-layer insulation film 12, the second inter-layer insulation film 13 and the third insulation film 31. The wirings 65a and 65b are connected to the driving IC chip 101 through the lead lines 63 and 64 illustrated in FIG. 1. In the embodiment, two wirings 65a and 65b are connected to one peripheral electrode 61; however, the wirings 65a and 65b may be a single wiring.

The conductive section electrode 66 is connected to the wiring 67 of the lower layer side through a contact hole formed by penetrating the first inter-layer insulation film 12, the second inter-layer insulation film 13 and the third insulation film 31. The wiring 67 is connected to the driving IC chip 101. The inter-substrate conductive section 106 such as the silver point is provided on the conductive section electrode 66.

The external circuit connection terminals 102 are connected to the wiring 69 of the lower layer side through a contact hole formed by penetrating the first inter-layer insulation film 12, the second inter-layer insulation film 13 and the third insulation film 31. The wiring 69 is connected to the driving IC chip 101.

A first orientation film 14 for covering the third insulation film 31 and the peripheral electrode 61 is formed on a surface of the element substrate 10 inside the seal material 51. That is, the first orientation film 14 for covering the pixel electrode 30, the dummy electrode 30D and the peripheral electrode 61 is formed in the display region 1A and the peripheral region 1B. As the first orientation film 14, an inorganic orientation film made of the silicon oxide film forming a columnar structure by oblique evaporation or the like or an organic orientation film such as polyimide or the like can be used. Furthermore, the first orientation film 14 may be extended to the region for forming the seal material 51 or to the region on the outside of the seal material 51. As described above, in this specification, the orientation film formed on the first substrate is referred to as the first orientation film 14.

An underlying insulation film 23 made of the silicon oxide film or the like is formed on a surface of the substrate body 20A of the second substrate in the liquid crystal material 50 side. The underlying insulation film 23 is formed such that a film thickness in an outer peripheral section of the substrate body 20A is thinner than that in a region on the inside of the seal material 51. That is, the underlying insulation film 23 has a step section 23d along an outer peripheral end of a light shielding film BM.

The light shielding film BM made of a metal film or a carbon film is formed on the underlying insulation film 23 in a region facing the peripheral electrode 61 on the element substrate 10. The light shielding film BM is formed as a rectangular frame-shaped peripheral partition which fringes the periphery of the dummy section 1D. The light shielding film BM may include a light shielding film as a black matrix for partitioning the pixels PX and the dummy pixels DM on a plane.

A protective insulation film 22 made of silicon nitride film or the like is formed by covering the light shielding film BM and the underlying insulation film 23. The protective insulation film 22 is an insulation film provided if necessary and may be omitted.

The common electrode 21 made of the transparent conductive material such as ITO is formed by covering the protective insulation film 22. In the embodiment, the common electrode 21 is also formed in a region facing the peripheral electrode 61 on the element substrate 10 and a part of the common electrode 21 configures the second peripheral electrode 62.

An insulation film 32 is formed by covering almost the entire surface of the common electrode 21. The insulation film 32 is formed using a material having a high resistance of double digits or more relative to the resistance value of the liquid crystal material 50 and, for example, is made of the silicon oxide film or the silicon nitride film. The film thickness of the insulation film 32 is not particularly limited if a high enough resistance value is obtained relative to the liquid crystal material in the film thickness. When the insulation film 32 is configured of the silicon oxide film or the silicon nitride film, it is possible to obtain a resistance value of approximately 100 times relative to the liquid crystal material 50 formed using a usual liquid crystal material with a film thickness of 100 nm or more and 400 nm or less.

The insulation film 32 has an opening section 32a corresponding to the position for forming the inter-substrate conductive section 106. The inter-substrate conductive section 106 is connected to the common electrode 21 which is exposed to the inside of the opening section 32a. The seal material 51 is provided on the liquid crystal material 50 side of the inter-substrate conductive section 106. An inner periphery end of the seal material 51 is disposed in a step portion of a surface of the opposite substrate 20 formed by the step section 23d.

A second orientation film 16 covering the insulation film 32 is formed on a surface of the opposite substrate 20 in a region surrounded by the seal material 51. That is, the common electrode 21 and the second orientation film 16 covering the common electrode are formed in the second substrate. The second orientation film 16 can be formed by the organic orientation film or the inorganic orientation film similar to the first orientation film 14 on the element substrate 10. Furthermore, the second orientation film 16 may be extended to a region for forming the seal material 51 or to a region of the outside of the seal material 51. Similar to the above description, in this specification, the orientation film formed on the second substrate is referred to as the second orientation film 16.

The liquid crystal material 50 is a liquid crystal material made using a longitudinal electric field method, which is driven by an electric field (longitudinal electric field) generated between the pixel electrode 30 and the common electrode 21 in the thickness direction of the liquid crystal material. For the longitudinal electric field method, a Vertical Alignment (VA) method is representative; however, other methods such as an Optically Compensated Birefringence (OCB) method or a Twisted Nematic (TN) method may be used.

Furthermore, in the embodiment, the liquid crystal material 50 is driven using the longitudinal electric field method in which the common electrode 21 is provided on an opposite substrate 20 side; however, the electrode functioning as the common electrode 21 is provided on an element substrate 10 side and the liquid crystal material 50 may be driven by an electric field (horizontal electric field: an electric field in a direction substantially orthogonal to the thickness direction of the liquid crystal material) generated between the electrode and the pixel electrode 30 in a plane direction of the substrate. Such a driving method is referred to as a horizontal electric field method. For the horizontal electrode film method, an In-Plane Switching (IPS) method or a Fringe Field Switching (FFS) method is representative. In this case, the second peripheral electrode 62 made of a conductive material such as ITO is formed on the surface of the opposite substrate 20 instead of the common electrode 21. The common potential V_{com} is supplied to the second peripheral electrode 62.

### Principle of Ion Capture

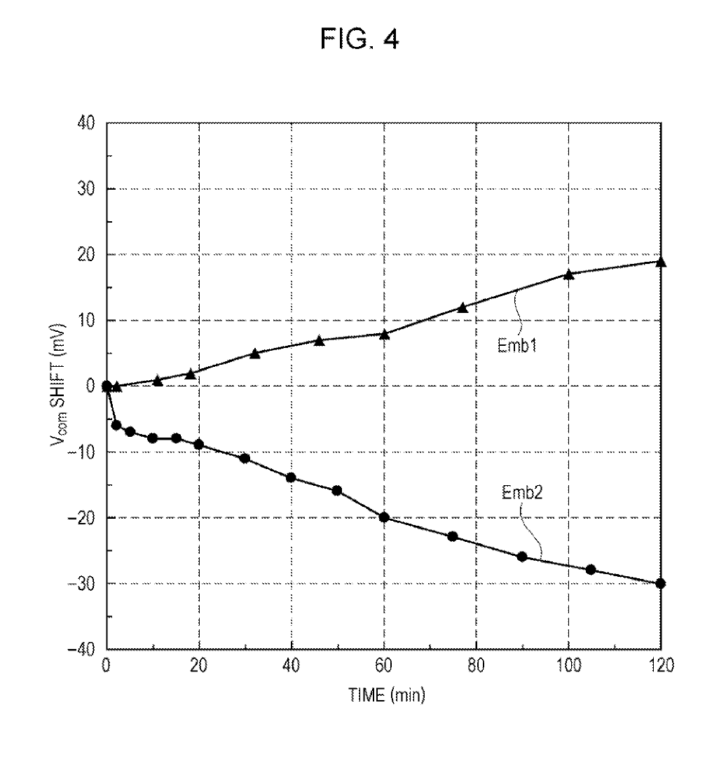

FIG. 3 is a schematic enlarged cross-sectional view of the liquid crystal device. In addition, FIG. 4 is a view describing a principle of ion capture. Next, a principle of ionic impurity capture will be described with reference to FIGS. 3 and 4.

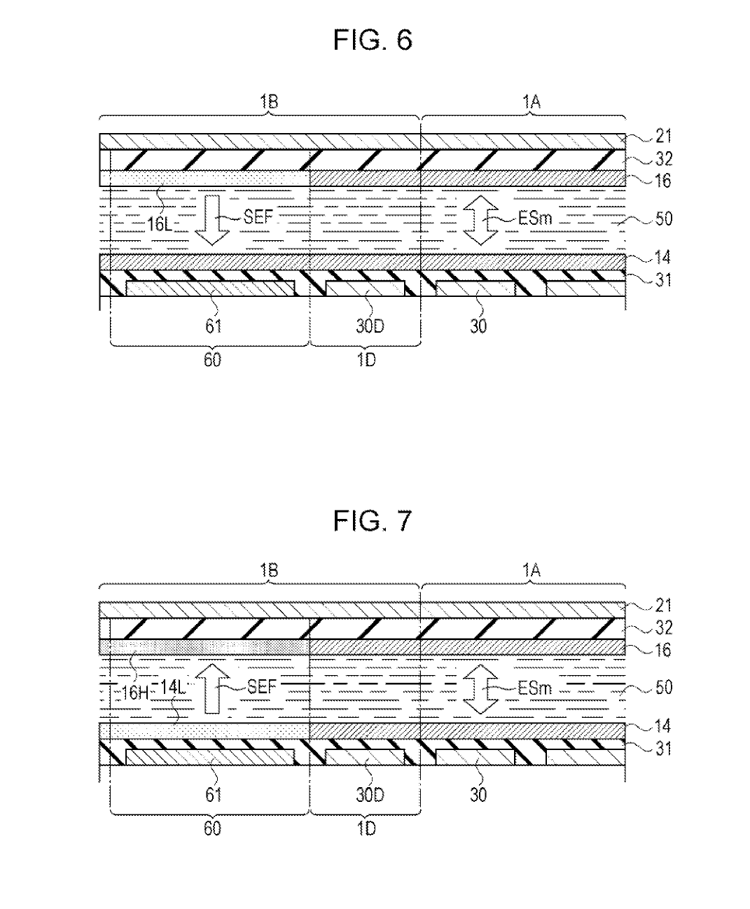

As illustrated in FIG. 3, in the electro-optical device, it is one of cases that a density of the first orientation film 14 formed in the display region 1A is different from a density of the first orientation film 14 (in the embodiment, a first orientation film 14L having a density lower than that of the first orientation film 14 formed in the display region 1A) formed in the peripheral region 1B or as described in the following embodiment 2 using FIG. 6, and a density of the second orientation film 16 formed in the display region 1A is different from a density of the second orientation film 16 (in the embodiment 2, a second orientation film 16L having a density lower than that of the second orientation film 16 formed in the display region 1A) formed in the peripheral region 1B. On the other hand, the density of the first orientation film 14 formed in the display region 1A is substantially the same as the density of the second orientation film 16 formed in the display region 1A and the orientation films are made of a homogeneous material. As a result, in the display region 1A, electric symmetry ESm is maintained between the first substrate and the second substrate, and temporal degradation of display quality is prevented. Broadly, in the electro-optical device, a difference between the density of the first orientation film 14 formed in the peripheral region 1B and the density of the second orientation film 16 formed in the peripheral region 1B is larger than a difference between the density of the first orientation film 14 formed in the display region 1A and the density of the second orientation film 16 formed in the display region 1A.

As illustrated in FIG. 3, when the density of the first orientation film 14 formed in the display region 1A is different from the density of the first orientation film 14L having a low density formed in the peripheral region 1B and the density of the second orientation film 16 formed in the display region 1A is substantially the same as the density of the second orientation film 16 formed in the peripheral region 1B, the density of the first orientation film 14L having a low density formed in the peripheral region 1B is different from the density of the second orientation film 16 formed in the peripheral region 1B, and an electric asymmetry is maintained in the peripheral region 1B. Therefore, an unusual electric field SEF having a large DC component is formed between the first substrate and the second substrate, and the ionic impurities present in the liquid crystal material 50 are efficiently captured by being accumulated in the ion trap section 60. In a word, as illustrated in FIG. 3, when the density of the first orientation film 14 formed in the display region 1A, the density of the second orientation film 16 formed in the display region 1A and the density of the second orientation film 16 formed in the peripheral region 1B are substantially the same as each other, and the density of the first orientation film 14 formed in the display region 1A is different from the density of the first orientation film 14L having a low density formed in the peripheral region 1B, it is possible to decrease display defects such as irregularity or stain to obtain high display quality, and it is possible to increase the display quality of the liquid crystal device 100 which is manufactured in a simple manufacturing process thereof, and to suppress the temporal degradation thereof without it being necessary to continuously apply a large voltage to the liquid crystal material 50. In other words, it is possible to achieve both the product life of the liquid crystal device 100 and a simple manufacturing process thereof.

In FIG. 4, when the density of the first orientation film 14 formed in the peripheral region 1B is different from the density of the second orientation film 16 formed in the peripheral region 1B, that the unusual electric field SEF having a large DC component is generated between the first substrate and the second substrate is described. The horizontal axis in FIG. 4 illustrates a time when an alternating electric field having an amplitude of a positive and negative 5 V (±5 V) is continuously applied to the liquid crystal material 50. A frequency of the alternating electric field is 60 Hz. The vertical axis in FIG. 4 illustrates that the unusual electric field SEF having the DC component is generated. When the alternating electric field is continuously applied to the liquid crystal material 50 in a state where the density of the first orientation film 14 is different from the density of the second orientation film 16, symmetry of a cathode driving (a state where the potential of the peripheral electrode 61 is higher than the common potential V_{com}) and an anode driving (a state where the potential of the peripheral electrode 61 is lower than the common potential V_{com}) is shifted. In a word, brightness displayed in the cathode driving is different from that displayed in the anode driving and flickering begins to stand out. This is because the electric asymmetry is generated in the liquid crystal material 50 and a residual DC component (the unusual electric field SEF) is generated between the upper and lower electrodes (between the common electrode 21 and the peripheral electrode 61). The common potential V_{com} is adjusted each time to minimize the flickering and the vertical axis in FIG. 4 illustrates the shift (common electrode shift V_{com} Shift).

In the embodiment, since the density of the second orientation film 16 is higher than the density of the first orientation film 14, a pre-tilt angle of the opposite substrate 20 side is approximately 1° and a pre-tilt angle of the element substrate 10 side is approximately 5°, and the common electrode shift V_{com} Shift is described by triangle marks (Emb1) in FIG. 4. In the invention, the residual DC component (the unusual electric field SEF) is a driving force which attracts the ionic impurities. FIG. 4 illustrates that the ionic impurities acquire the driving force by a gradient in the plane of the residual DC component (the unusual electric field SEF). When a large residual DC component (the unusual electric field SEF) to attract ions in the display region 1A is generated, the display quality is decreased; however, even though the residual DC component is generated in the peripheral region 1B that is a non-display region, it is not a problem because the ion trap section 60 is covered in the light shielding film BM and then is not visible to a user. Therefore, the technology of this application in which a large residual DC component (the unusual electric field SEF) is generated on the peripheral electrode 61 provided in the non-display region and the ionic impurities are selectively accumulated is extremely useful.

As described above, in the liquid crystal device 100 in which the density of the orientation film is different between the first substrate and the second substrate, the large residual DC component (the unusual electric field SEF) is generated. This is because the pre-tilt angle varies depending on the density of the orientation film. As the embodiment, when the density of the second orientation film 16 of the opposite substrate 20 side is higher than the density of the first orientation film 14 of the element substrate 10 side, the pre-tilt angle of the opposite substrate 20 side is smaller than the pre-tilt angle of the element substrate 10 side (approaches the vertical orientation) and then the large residual DC component (the unusual electric field SEF) of the cathode is generated in the liquid crystal device 100. As a result, since negative ions are accumulated and captured on the peripheral electrode 61 side of the ion trap section 60, it is possible to prevent the degradation of the display quality due to the ionic impurities in the display region 1A. Furthermore, as a parameter for controlling the density of the orientation film and the pre-tilt angle which is varied as a result thereof when manufacturing, a vacuum degree, a processing temperature or the like is exemplified when performing evaporation on the orientation film; however, the film forming conditions are not particularly limited.

Eventually, in the electro-optical device, it is one of cases that the pre-tilt angle of the first substrate side in the display region 1A is different from the pre-tilt angle of the first substrate side in the peripheral region 1B or the pre-tilt angle of the second substrate side in the display region 1A is different from the pre-tilt angle of the second substrate in the peripheral region 1B, as described in the following embodiment 2. On the other hand, the pre-tilt angle of the first substrate side in the display region 1A is substantially the same as the pre-tilt angle of the second substrate side in the display region 1A. As a result, in the display region 1A, the electric symmetry ESm is maintained between the first substrate and the second substrate, and the temporal degradation of the display quality is prevented.

When the pre-tilt angle of the first substrate side in the display region 1A is different from the pre-tilt angle of the first substrate side in the peripheral region 1B and the pre-tilt angle of the second substrate side in the display region 1A is substantially the same as the pre-tilt angle of the second substrate side in the peripheral region 1B, the pre-tilt angle of the first substrate side in the peripheral region 1B is different from the pre-tilt angle of the second substrate side in the peripheral region 1B and the electric asymmetry is maintained in the peripheral region 1B. Therefore, the unusual electric field SEF having the large DC component is formed between the first substrate and the second substrate, and the ionic impurities present in the liquid crystal material 50 are efficiently captured by being accumulated in the ion trap section 60. In a word, when the pre-tilt angle of the first substrate side in the display region 1A, the pre-tilt angle of the second substrate side in the display region 1A and the pre-tilt angle of the second substrate side in the peripheral region 1B are substantially the same as each other, and the pre-tilt angle of the first substrate side in the display region 1A is different from the pre-tilt angle of the first substrate formed in the peripheral region 1B, it is possible to decrease display defects such as irregularity or stain to obtain high display quality, and it is possible to increase the display quality of the liquid crystal device which is manufactured in a simple manufacturing process, and to suppress the temporal degradation thereof without it being necessary to continuously apply a large voltage to the liquid crystal material. In other words, it is possible to achieve both the product life of the liquid crystal device and a simple manufacturing process thereof.

It is preferable that a value of the density of the first orientation film 14 or the second orientation film 16 be in a range from 1.8 g/cm³ to 2 g/cm³, when the orientation films are the inorganic orientation film made of the silicon oxide film (SiO₂ film). The silicon oxide film having such a density can be manufactured by adjusting manufacturing conditions such as an oblique evaporation method. It is preferable that the asymmetry between the high density and the low density in the first orientation film 14 and the second orientation film 16, respectively be maintained in the peripheral region 1B within the density range from 1.8 g/cm³ to 2 g/cm³. In addition, it is preferable that the pre-tilt angle be in a range of from 1° to 5°. In the range, it is preferable that the asymmetry in the high pre-tilt angle and the low pre-tilt angle between the first substrate side and the second substrate side be maintained in the peripheral region 1B. Furthermore, when the pre-tilt angle is varied between the first substrate side and the second substrate side in the peripheral region 1B, the first orientation film 14 or the second orientation film 16 is not limited to the inorganic film and may be an organic film such as polyimide.

Since the first orientation film 14, the first orientation film 14L having the low density and the second orientation film 16 are formed using the insulation film which is used for a configuration material of the liquid crystal device 100 of the related art such as the silicon oxide film or the silicon nitride film, a specific material or manufacturing process is not required to form the films. Therefore, even though the ion trap section 60 is provided, manufacturability of the liquid crystal device 100 is not impaired. In addition, it is possible to easily make and separate the first orientation film 14 and the first orientation film 14L having the low density with a so-called mask evaporation method using a mask where an opening section is provided only at a necessary point.

In the embodiment, the density of the first orientation film 14 formed in the display region 1A, the density of the second orientation film 16 formed in the display region 1A and the density of the second orientation film 16 formed in the peripheral region 1B are substantially the same as each other, and the density of the first orientation film 14L having the low density formed in the peripheral region 1B is lower than the density of the first orientation film 14 formed in the display region 1A. Therefore, the pre-tilt angle of the first substrate side in the display region 1A, the pre-tilt angle of the second substrate side in the display region 1A and the pre-tilt angle of the second substrate side in the peripheral region 1B are substantially the same as each other, and the pre-tilt angle of the first substrate side in the display region 1A is smaller than the pre-tilt angle of the first substrate side in the peripheral region 1B. In contrast, the density of the first orientation film 14 formed the display region 1A, the density of the second orientation film 16 formed in the display region 1A and the density of the second orientation film 16 formed in the peripheral region 1B are substantially the same as each other, and the density of the first orientation film 14 formed in the peripheral region 1B may be higher than the density of the first orientation film 14 formed in the display region 1A. In this case, the pre-tilt angle of the first substrate side in the display region 1A, the pre-tilt angle of the second substrate side in the display region 1A and the pre-tilt angle of the second substrate side in the peripheral region 1B are substantially the same as each other, and the pre-tilt angle of the first substrate side in the display region 1A is larger than the pre-tilt angle of the first substrate side in the peripheral region 1B. When taking such a configuration, positive ionic impurities present in the liquid crystal material 50 are efficiently captured by being accumulated in the vicinity of the peripheral electrode 61 of the ion trap section 60.

Furthermore, if the densities of the orientation films are substantially the same as each other, it is not intended for the films to be different when manufacturing the orientation films. Similarly, if the pre-tilt angles are substantially the same as each other, it is not intended for the pre-tilt angles to be different in the manufacturing process for determining the pre-tilt angle.

### Peripheral Electrode Signal

In the liquid crystal device 100, the electric field generated between the peripheral electrode 61 and the second peripheral electrode 62 (the common electrode 21) acts on the liquid crystal material 50 and the ionic impurities in the liquid crystal material 50 are captured by supplying the peripheral electrode signal V11 to the peripheral electrode 61 before the image is displayed, while the image is displayed and after the image is displayed. Therefore, it is possible to fix the ionic impurities generated in the display region 1A or the ionic impurities eluted from the seal material 51 or the sealant 52 to the peripheral region 1B. As a result, it is possible to suppress a situation that the ionic impurities are adsorbed on the orientation film or the like in the display region 1A and to provide the liquid crystal device having fewer display defects such as image burn-in or irregularity caused by the adsorption.

The peripheral electrode signal V11 applied to the peripheral electrode 61 is the alternating potential having the positive and negative amplitude relative to the common potential V_{com}. For example, the frequency of the alternating potential is 240 Hz. As a result, since the alternating electric field is applied to the liquid crystal material 50 in the ion trap section 60, it is possible to effectively capture the ionic impurities in the liquid crystal material 50.

Furthermore, in the embodiment, a case is described where the ion trap section 60 surrounds the display region 1A and is the rectangular frame-shape in a plan view; however, the invention is not limited to the configuration. For example, a configuration may be used in which a plurality of ion trap sections 60 (peripheral electrodes 61) are intermittently disposed in the peripheral region 1B. Otherwise, a configuration may be used in which the ion trap section 60 is provided only in a position corresponding to a corner section (particularly, a corner section in which display defects such as irregularity or stain easily occur and which is positioned in the orientation direction of liquid crystal molecules) of the display region 1A and a linear ion trap section 60 is provided along a peripheral edge of the display region 1A. As another example, a configuration may be used in which a plurality of rectangular frame-shaped ion trap sections 60 are disposed in a double frame shape or a triple frame shape.

### Electronic Apparatus

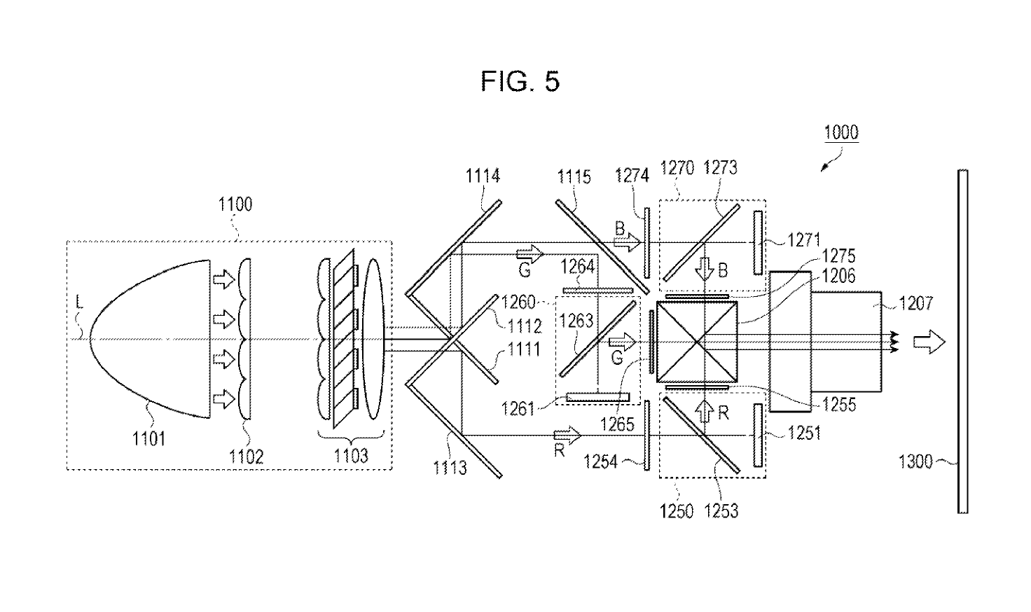

FIG. 5 is a schematic view illustrating a configuration of a projection type display device as an electronic apparatus. Next, the electronic apparatus of the embodiment will be described with reference to FIG. 5.

As illustrated in FIG. 5, a projection type display device 1000 as the electronic apparatus of the embodiment includes a polarization illuminating device 1100, three dichroic mirrors 1111, 1112 and 1115, two reflective mirrors 1113 and 1114, three reflective type liquid crystal light bulbs 1250, 1260 and 1270 as light modulation elements, a cross dichroic prism 1206, and a projection lens 1207 which are disposed along an optical axis of a system.

The polarization illuminating device 1100 is schematically configured of a lamp unit 1101 as a light source consisting of a white light source such as a halogen lamp, an integrator lens 1102 and a polarization conversion element 1103.

Polarized luminous flux emitted from the polarization illuminating device 1100 is incident on the dichroic mirror 1111 and the dichroic mirror 1112 which are disposed orthogonal to each other. The dichroic mirror 1111 as a light separation element reflects the red light R in the incident polarized luminous flux. The dichroic mirror 1112 as the other light separation element reflects the green light G and the blue light B in the incident polarized luminous flux.

The reflected red light R is reflected again by the reflective mirror 1113 and is incident on the liquid crystal light bulb 1250. On the other hand, the reflected green light G and blue light B are reflected again by the reflective mirror 1114 and are incident on the dichroic mirror 1115 as the light separation element. The dichroic mirror 1115 reflects the green light G and transmits the blue light B. The reflected green light G is incident on the liquid crystal light bulb 1260. The transmitted blue light B is incident on the liquid crystal light bulb 1270.

The liquid crystal light bulb 1250 includes a reflective type liquid crystal panel 1251 (the liquid crystal device 100), and a wire-grid polarization plate 1253 as a reflective type polarization element. The liquid crystal light bulb 1250 is disposed in such a manner that the red light R reflected by the wire-grid polarization plate 1253 is incident in a direction perpendicular to the incident surface of the cross dichroic prism 1206. In addition, an auxiliary polarization plate 1254 compensating the degree of the polarization of the wire-grid polarization plate 1253 is disposed on the incident side of the red light R in the liquid crystal light bulb 1250. In addition, the other auxiliary polarization plate 1255 is disposed along the incident surface of the cross dichroic prism 1206 in the emitting side of the red light R. In addition, when the polarization beam splitter is used as the reflective type polarization element, a pair of auxiliary polarization plates 1254 and 1255 may be omitted. Configurations and disposition of each configuration of the reflective type liquid crystal light bulb 1250 are the same as the other reflective type liquid crystal light bulbs 1260 and 1270.

Each color light incident on the liquid crystal light bulbs 1250, 1260 and 1270 is modulated, based on the image information, and is incident again on the cross dichroic prism 1206 via the wire-grid polarization plates 1253, 1263 and 1273. In the cross dichroic prism 1206, each color light is synthesized, the synthesized light is projected onto a screen 1300 by the projection lens 1207 and the image is enlarged, thereby being displayed.

In the embodiment, as reflective type liquid crystal panels 1251, 1261 and 1271 in the liquid crystal light bulbs 1250, 1260 and 1270, the above described reflective type liquid crystal device 100 is applied in the embodiment.

According to the projection type display device 1000 described above, since the reflective type liquid crystal device 100 is used in the liquid crystal light bulbs 1250, 1260 and 1270, it is possible to provide the reflective type projection type display device 1000 capable of projecting a bright image and capable of speedy driving. When taking such a configuration, it is possible to manufacture the electronic apparatus having high display quality and the long product life with a relatively simple manufacturing process.

As described above, in the electro-optical device of the embodiment, since the first orientation film 14 and the second orientation film 16 formed in the display region 1A are made of the homogeneous material, it is possible to maintain the electric symmetry ESm between the substrates and to prevent the temporal degradation of the display quality. Furthermore, since the density of the first orientation film 14L having the low density formed in the peripheral region 1B is different from the density of the second orientation film 16 formed in the peripheral region 1B, the electric asymmetry is maintained in the peripheral region. Therefore, the unusual electric field SEF is formed between the first substrate and the second substrate, and it is possible to efficiently capture the ionic impurities present in the liquid crystal material 50. That is, it is possible to decrease display defects such as irregularity or stain to obtain high display quality, and it is possible to suppress the decrease in the high display quality of the liquid crystal device 100 manufactured in a simple manufacturing process without it being necessary to continuously apply a large voltage to the liquid crystal material 50. In other words, it is possible to achieve both the product life of the liquid crystal device 100 and a simple manufacturing process thereof.

### Embodiment 2

### Form Having Different Second Orientation Film

FIG. 6 is a schematic enlarged cross-sectional view of a liquid crystal device. Next, a form in which the second orientation film 16 is different from the embodiment 1 will be described with reference to FIGS. 6 and 4. In addition, for the same configuration parts as the embodiment 1, the same symbols are given and redundant description will be omitted.

In the embodiment (FIG. 6), forms of the first orientation film 14 and the second orientation film 16 are different from those of the embodiment 1 (FIG. 3). The other configurations are substantially the same as the embodiment 1. Even in such a configuration, the same effects as the embodiment 1 can be obtained. In the electro-optical device of the embodiment, as illustrated in FIG. 6, the density of the second orientation film 16 formed in the display region 1A is different from the density of the second orientation film 16 (in the embodiment, the second orientation film 16L having the low density) formed in the peripheral region 1B. Similar to the embodiment 1, the density of the first orientation film 14 formed in the display region 1A is substantially the same as the density of the second orientation film 16 formed in the display region 1A, and the orientation films are made of the homogeneous material. As a result, it is possible to maintain the electric symmetry ESm between the first substrate and the second substrate and to prevent the temporal degradation of the display quality in the display region 1A.

As illustrated in FIG. 6, when the density of the second orientation film 16 formed in the display region 1A is different from the density of the second orientation film 16L having the low density formed in the peripheral region 1B and the density of the first orientation film 14 formed in the display region 1A is substantially the same as the density of the first orientation film 14 formed in the peripheral region 1B, the density of the second orientation film 16L having the low density formed in the peripheral region 1B is different from the density of the first orientation film 14 formed in the peripheral region 1B, and an electric asymmetry is maintained in the peripheral region 1B. Therefore, the unusual electric field SEF having a large DC component is formed between the first substrate and the second substrate, and the ionic impurities present in the liquid crystal material 50 are efficiently captured by being accumulated in the ion trap section 60. In a word, as illustrated in FIG. 6, when the density of the second orientation film 16 formed in the display region 1A, the density of the first orientation film 14 formed in the display region 1A and the density of the first orientation film 14 formed in the peripheral region 1B are substantially the same as each other, and the density of the second orientation film 16 formed in the display region 1A is different from the density of the second orientation film 16L having the low density formed in the peripheral region 1B, it is possible to decrease display defects such as irregularity or stain to obtain high display quality, and it is possible to increase the display quality of the liquid crystal device 100 which is manufactured in a simple manufacturing process, and to suppress the temporal degradation thereof without it being necessary to continuously apply a large voltage to the liquid crystal material 50. In other words, it is possible to achieve both a product life of the liquid crystal device 100 and a simple manufacturing process thereof.

In the embodiment, since the density of the second orientation film 16L having the low density is lower than the density of the first orientation film 14 in the peripheral region 1B, a pre-tilt angle of the opposite substrate 20 side is approximately 5° and a pre-tilt angle of the element substrate 10 side is approximately 1° in the peripheral region 1B, and the common electrode shift V_{com} Shift is described by circle marks (Emb2) in FIG. 4. As in the embodiment, when the density of the second orientation film 16L having the low density of the opposite substrate 20 side is lower than the density of the first orientation film 14 of the element substrate 10 side, the pre-tilt angle of the opposite substrate 20 side is larger than the pre-tilt angle of the element substrate 10 side and then a large residual DC component (the unusual electric field SEF) of the anode is generated in the liquid crystal device 100. As a result, since the positive ions are captured on the peripheral electrode 61 side of the ion trap section 60, it is possible to suppress the decrease in the display quality due to ionic impurities in the display region 1A.

In the embodiment, the pre-tilt angle of the second substrate side in the display region 1A is different from the pre-tilt angle of the second substrate side in the peripheral region 1B and the pre-tilt angle of the first substrate side in the display region 1A is substantially the same as the pre-tilt angle of the first substrate side in the peripheral region 1B. As a result, the pre-tilt angle of the second substrate side in the peripheral region 1B is different from the pre-tilt angle of the first substrate side in the peripheral region 1B and the electric asymmetry is maintained in the peripheral region 1B. Therefore, the unusual electric field SEF having a large DC component is formed between the first substrate and the second substrate, and the ionic impurities present in the liquid crystal material 50 are efficiently captured by being accumulated in the ion trap section 60. In a word, when the pre-tilt angle of the first substrate side in the display region 1A, the pre-tilt angle of the second substrate side in the display region 1A and the pre-tilt angle of the first substrate side in the peripheral region 1B are substantially the same as each other, and the pre-tilt angle of the second substrate side in the display region 1A is different from the pre-tilt angle of the second substrate side in the peripheral region 1B, it is possible to decrease display defects such as irregularity or stain to obtain high display quality, and it is possible to increase the display quality of the liquid crystal device 100 which is manufactured in a simple manufacturing process, and to suppress the temporal degradation thereof without it being necessary to continuously apply a large voltage to the liquid crystal material 50. In other words, it is possible to achieve both the product life of the liquid crystal device 100 and a simple manufacturing process thereof.

In the embodiment, the density of the first orientation film 14 formed in the display region 1A, the density of the second orientation film 16 formed in the display region 1A and the density of the first orientation film 14 formed in the peripheral region 1B are substantially the same as each other, and the density of the second orientation film 16L having the low density formed in the peripheral region 1B is lower than the density of the second orientation film 16 formed in the display region 1A. Therefore, the pre-tilt angle of the first substrate side in the display region 1A, the pre-tilt angle of the second substrate side in the display region 1A and the pre-tilt angle of the first substrate side in the peripheral region 1B are substantially the same as each other, and the pre-tilt angle of the second substrate side in the display region 1A is smaller than the pre-tilt angle of the second substrate side in the peripheral region 1B. In contrast, the density of the first orientation film 14 formed the display region 1A, the density of the second orientation film 16 formed in the display region 1A and the density of the first orientation film 14 formed in the peripheral region 1B are substantially the same as each other, and the density of the second orientation film 16 formed in the peripheral region 1B may be higher than the density of the second orientation film 16 formed in the display region 1A. In this case, the pre-tilt angle of the first substrate side in the display region 1A, the pre-tilt angle of the second substrate side in the display region 1A and the pre-tilt angle of the first substrate side in the peripheral region 1B are substantially the same as each other, and the pre-tilt angle of the second substrate side in the display region 1A is larger than the pre-tilt angle of the second substrate side in the peripheral region 1B. When taking such a configuration, negative ionic impurities present in the liquid crystal material 50 are efficiently captured by being accumulated in the vicinity of the peripheral electrode 61 of the ion trap section 60.

### Embodiment 3

### Form 1 Having Different First Orientation Film and Second Orientation Film

FIG. 7 is a schematic enlarged cross-sectional view of a liquid crystal device. Next, a form in which the first orientation film 14 and the second orientation film 16 are different from the embodiment 1 will be described with reference to FIG. 7. In addition, for the same configuration parts as the embodiments 1 and 2, the same symbols are given and redundant description will be omitted.

In the embodiment (FIG. 7), forms of the first orientation film 14 and the second orientation film 16 are different from those of the embodiment 1 (FIG. 3). The other configurations are substantially the same as the embodiment 1. Even in such a configuration, the same effects as the embodiment 1 can be obtained. In the electro-optical device of the embodiment, as illustrated in FIG. 7, the density of the first orientation film 14 formed in the display region 1A is different from the density of the first orientation film 14 (in the embodiment, the first orientation film 14L having the low density) formed in the peripheral region 1B and the density of the second orientation film 16 formed in the display region 1A is different from the density of the second orientation film 16 (in the embodiment, a second orientation film 16H having a high density) formed in the peripheral region 1B. Similar to the embodiment 1, the density of the first orientation film 14 formed in the display region 1A is substantially the same as the density of the second orientation film 16 formed in the display region 1A, and the orientation films are made of the homogeneous material. As a result, it is possible to maintain the electric symmetry ESm between the first substrate and the second substrate to prevent the temporal degradation of the display quality in the display region 1A.

As illustrated in FIG. 7, when the density of the second orientation film 16 formed in the display region 1A is different from the density of the second orientation film 16H having the high density formed in the peripheral region 1B, the density of the first orientation film 14 formed in the display region 1A is different from the density of the first orientation film 14L having the low density formed in the peripheral region 1B, the density of the second orientation film 16 formed in the display region 1A is substantially the same as the density of the first orientation film 14 formed in the display region 1A, the density of the second orientation film 16H having the high density formed in the peripheral region 1B is different from the density of the first orientation film 14L having the low density formed in the peripheral region 1B, and an electric asymmetry is maintained in the peripheral region 1B. Therefore, the unusual electric field SEF having a large DC component is formed between the first substrate and the second substrate, and the ionic impurities present in the liquid crystal material 50 are efficiently captured by being accumulated in the ion trap section 60. In a word, as illustrated in FIG. 7, when the density of the first orientation film 14 formed in the display region 1A is substantially the same as the density of the second orientation film 16 formed in the display region 1A, the density of the first orientation film 14L having the low density formed in the peripheral region 1B is different from the density of the second orientation film 16H having the high density formed in the peripheral region 1B, the density of the first orientation film 14 formed in the display region 1A is different from the density of the first orientation film 14L having the low density formed in the peripheral region 1B, and the density of the second orientation film 16 formed in the display region 1A is different from the density of the second orientation film 16H having the high density formed in the peripheral region 1B, it is possible to decrease display defects such as irregularity or stain to obtain high display quality, and it is possible to increase the display quality of the liquid crystal device 100 which is manufactured in a simple manufacturing process, and to suppress the temporal degradation thereof without it being necessary to continuously apply a large voltage to the liquid crystal material 50. In other words, it is possible to achieve both a product life of the liquid crystal device 100 and a simple manufacturing process thereof. Furthermore, in the embodiment, the density of the first orientation film 14L having the low density is 1.8 g/cm³, the density of the first orientation film 14 formed in the display region 1A and the density of the second orientation film 16 formed in the display region 1A are 1.9 g/cm³, and the density of the second orientation film 16H having the high density is 2.0 g/cm³.

In the embodiment, the pre-tilt angle of the first substrate side in the display region 1A is different from the pre-tilt angle of the first substrate side in the peripheral region 1B, the pre-tilt angle of the second substrate side in the display region 1A is different from the pre-tilt angle of the second substrate side in the peripheral region 1B, and the pre-tilt angle of the first substrate side in the display region 1A is substantially the same as the pre-tilt angle of the second substrate side in the display region 1A. As a result, the pre-tilt angle of the second substrate side in the peripheral region 1B is different from the pre-tilt angle of the first substrate side in the peripheral region 1B and the electric asymmetry is maintained in the peripheral region 1B. Therefore, the unusual electric field SEF having a large DC component is formed between the first substrate and the second substrate, and the ionic impurities present in the liquid crystal material 50 are efficiently captured by being accumulated in the ion trap section 60. In a word, when the pre-tilt angle of the first substrate side in the display region 1A, and the pre-tilt angle of the second substrate side in the display region 1A are substantially the same as each other, and the pre-tilt angle of the first substrate side in the peripheral region 1B is different from the pre-tilt angle of the second substrate in the peripheral region 1B, it is possible to decrease display defects such as irregularity or stain to obtain high display quality, and it is possible to increase the display quality of the liquid crystal device 100 which is manufactured in a simple manufacturing process, and to suppress the temporal degradation thereof without it being necessary to continuously apply a large voltage to the liquid crystal material 50. In other words, it is possible to achieve both the product life of the liquid crystal device 100 and a simple manufacturing process thereof.

In the embodiment, the density of the first orientation film 14 formed in the display region 1A is substantially the same as the density of the second orientation film 16 formed in the display region 1A, the density of the first orientation film 14L having the low density formed in the peripheral region 1B is lower than the density of the first orientation film 14 formed in the display region 1A, and the density of the second orientation film 16H having the high density formed in the peripheral region 1B is higher than the density of the second orientation film 16 formed in the display region 1A. Therefore, the pre-tilt angle of the first substrate side in the display region 1A is substantially the same as the pre-tilt angle of the second substrate side in the display region 1A, the pre-tilt angle of the first substrate side in the display region 1A is smaller than the pre-tilt angle of the first substrate side in the peripheral region 1B, and the pre-tilt angle of the second substrate side in the display region 1A is larger than the pre-tilt angle of the second substrate side in the peripheral region 1B. When taking such a configuration, since a difference of pre-tilt angles between substrates in the peripheral region 1B is large, the unusual electric field SEF also becomes strong and negative ionic impurities present in the liquid crystal material 50 are efficiently captured by being accumulated in the vicinity of the peripheral electrode 61 of the ion trap section 60.

### Embodiment 4

### Form 2 Having Different First Orientation Film and Second Orientation Film

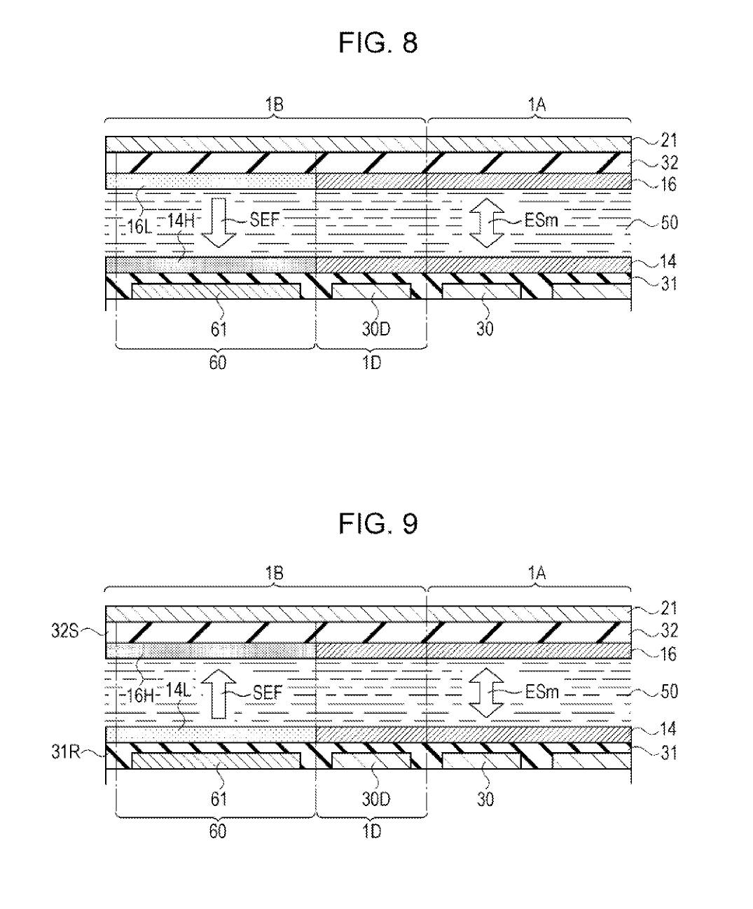

FIG. 8 is a schematic enlarged cross-sectional view of a liquid crystal device. Next, a form in which the first orientation film 14 and the second orientation film 16 are different from the embodiments 1 to 3 will be described with reference to FIG. 8. In addition, for the same configuration parts as the embodiments 1 to 3, the same symbols are given and redundant description will be omitted.

In the embodiment (FIG. 8), forms of the first orientation film 14 and the second orientation film 16 are different from those of the embodiment 3 (FIG. 7). The other configurations are substantially the same as the embodiment 3. Even in such a configuration, the same effects as the embodiments 1 to 3 can be obtained. In the electro-optical device of the embodiment, as illustrated in FIG. 8, the density of the first orientation film 14 formed in the display region 1A is different from the density of the first orientation film 14 (in the embodiment, a first orientation film 14H having a high density) formed in the peripheral region 1B and the density of the second orientation film 16 formed in the display region 1A is different from the density of the second orientation film 16 (in the embodiment, a second orientation film 16L having a low density) formed in the peripheral region 1B. Similar to the embodiment 1, the density of the first orientation film 14 formed in the display region 1A is substantially the same as the density of the second orientation film 16 formed in the display region 1A, and the orientation films are made of the homogeneous material. As a result, it is possible to maintain the electric symmetry ESm between the first substrate and the second substrate and to prevent the temporal degradation of the display quality in the display region 1A.

As illustrated in FIG. 8, when the density of the second orientation film 16 formed in the display region 1A is different from the density of the second orientation film 16L having the low density formed in the peripheral region 1B, the density of the first orientation film 14 formed in the display region 1A is different from the density of the first orientation film 14H having the high density formed in the peripheral region 1B, the density of the second orientation film 16 formed in the display region 1A is substantially the same as the density of the first orientation film 14 formed in the display region 1A, the density of the second orientation film 16L having the low density formed in the peripheral region 1B is different from the density of the first orientation film 14H having the high density formed in the peripheral region 1B, and an electric asymmetry is maintained in the peripheral region 1B. Therefore, the unusual electric field SEF having a large DC component is formed between the first substrate and the second substrate, and the ionic impurities present in the liquid crystal material 50 are efficiently captured by being accumulated in the ion trap section 60. In a word, as illustrated in FIG. 8, when the density of the first orientation film 14 formed in the display region 1A is substantially the same as the density of the second orientation film 16 formed in the display region 1A, the density of the first orientation film 14H having the high density formed in the peripheral region 1B is different from the density of the second orientation film 16L having the low density formed in the peripheral region 1B, the density of the first orientation film 14 formed in the display region 1A is different from the density of the first orientation film 14H having the high density formed in the peripheral region 1B, and the density of the second orientation film 16 formed in the display region 1A is different from the density of the second orientation film 16L having the low density formed in the peripheral region 1B, it is possible to decrease display defects such as irregularity or stain to obtain high display quality, and it is possible to increase the display quality of the liquid crystal device 100 which is manufactured in a simple manufacturing process, and to suppress the temporal degradation thereof without it being necessary to continuously apply a large voltage to the liquid crystal material 50. In other words, it is possible to achieve both a product life of the liquid crystal device 100 and a simple manufacturing process thereof. Furthermore, in the embodiment, the density of the first orientation film 14H having the high density is 2.0 g/cm³, the density of the first orientation film 14 formed in the display region 1A and the density of the second orientation film 16 formed in the display region 1A are 1.9 g/cm³, and the density of the second orientation film 16L having the low density is 1.8 g/cm³.

In the embodiment, the pre-tilt angle of the first substrate side in the display region 1A is different from the pre-tilt angle of the first substrate side in the peripheral region 1B, the pre-tilt angle of the second substrate side in the display region 1A is different from the pre-tilt angle of the second substrate side in the peripheral region 1B, and the pre-tilt angle of the first substrate side in the display region 1A is substantially the same as the pre-tilt angle of the second substrate side in the display region 1A. As a result, the pre-tilt angle of the second substrate side in the peripheral region 1B is different from the pre-tilt angle of the first substrate side in the peripheral region 1B and the electric asymmetry is maintained in the peripheral region 1B. Therefore, the unusual electric field SEF having a large DC component is formed between the first substrate and the second substrate, and the ionic impurities present in the liquid crystal material 50 are efficiently captured by being accumulated in the ion trap section 60. In a word, when the pre-tilt angle of the first substrate side in the display region 1A is substantially the same as the pre-tilt angle of the second substrate side in the display region 1A and the pre-tilt angle of the first substrate side in the peripheral region 1B is different from the pre-tilt angle of the second substrate side in the peripheral region 1B, it is possible to decrease display defects such as irregularity or stain to obtain high display quality, and it is possible to increase the display quality of the liquid crystal device 100 which is manufactured in a simple manufacturing process, and to suppress the temporal degradation thereof without it being necessary to continuously apply a large voltage to the liquid crystal material 50. In other words, it is possible to achieve both the product life of the liquid crystal device 100 and a simple manufacturing process thereof.

In the embodiment, the density of the first orientation film 14 formed in the display region 1A is substantially the same as the density of the second orientation film 16 formed in the display region 1A, the density of the first orientation film 14H having the high density formed in the peripheral region 1B is higher than the density of the first orientation film 14 formed in the display region 1A, and the density of the second orientation film 16L having the low density formed in the peripheral region 1B is lower than the density of the second orientation film 16 formed in the display region 1A. Therefore, the pre-tilt angle of the first substrate side in the display region 1A is substantially the same as the pre-tilt angle of the second substrate side in the display region 1A, the pre-tilt angle of the first substrate side in the display region 1A is larger than the pre-tilt angle of the first substrate side in the peripheral region 1B, and the pre-tilt angle of the second substrate side in the display region 1A is smaller than the pre-tilt angle of the second substrate side in the peripheral region 1B. When taking such a configuration, since difference of pre-tilt angle between substrates in the peripheral region 1B is large, the unusual electric field SEF also becomes strong and the positive ionic impurities present in the liquid crystal material 50 are efficiently captured by being accumulated in the vicinity of the peripheral electrode 61 of the ion trap section 60.

### Embodiment 5

### Form 1 Having Different Insulation Film

FIG. 9 is a schematic enlarged cross-sectional view of a liquid crystal device. Next, a form in which the third insulation film 31 and the insulation film 32 are different from the embodiment 3 will be described with reference to FIG. 9. In addition, for the same configuration parts as the embodiments 1 to 4, the same symbols are given and redundant description will be omitted.

In the embodiment (FIG. 9), forms of the third insulation film 31 and the insulation film 32 are different from those of the embodiment 3 (FIG. 7). The other configurations are substantially the same as the embodiment 3. Even in such a configuration, the same effects as the embodiment 3 can be obtained. In the embodiments 1 to 4, the manufacturing process may be changed by using the mask evaporation method to make and separate the first orientation film 14 or the second orientation film 16, depending on the region. Meanwhile, in the electro-optical device of the embodiment, as illustrated in FIG. 9, the density of the orientation film is varied by changing the configuration of the electro-optical device. The density of the film of the orientation film is varied by a surface roughness of the underlying film positioned in the lower layer thereof. According to the study of inventors of this application, as the surface of the underlying film is rough, the density of the orientation film formed on the upper layer thereof is decreased. Accordingly, in the embodiment, one of the third insulation film 31 or the insulation film 32, or both the third insulation film 31 and the insulation film 32 are made of a material different from the display region 1A and the peripheral region 1B. As the third insulation film 31 or the insulation film 32 which is the underlying film, the silicon oxide film or the silicon nitride film can be used and it may be used as a passivation film.

As illustrated in FIG. 9, in the ion trap section 60, when the underlying film is a third insulation film 31R having a large surface roughness, the first orientation film 14 formed on the upper layer side thereof is the first orientation film 14L having the low density, and when the underlying film is an insulation film 32S having a small surface roughness, the second orientation film 16 formed in the upper layer thereof is the second orientation film 16H having the high density. Thus, the same configuration as the embodiment 3 is realized, the unusual electric field SEF having a large DC component is formed between the first substrate and the second substrate in the peripheral region 1B, and the ionic impurities present in the liquid crystal material 50 are efficiently captured by being accumulated in the ion trap section 60. As a result, since difference of pre-tilt angle between substrates in the peripheral region 1B is large, the unusual electric field SEF also becomes strong and the negative ionic impurities present in the liquid crystal material 50 are efficiently captured by being accumulated in the vicinity of the peripheral electrode 61 of the ion trap section 60.

### Embodiment 6

### Form 2 Having Different Insulation Film

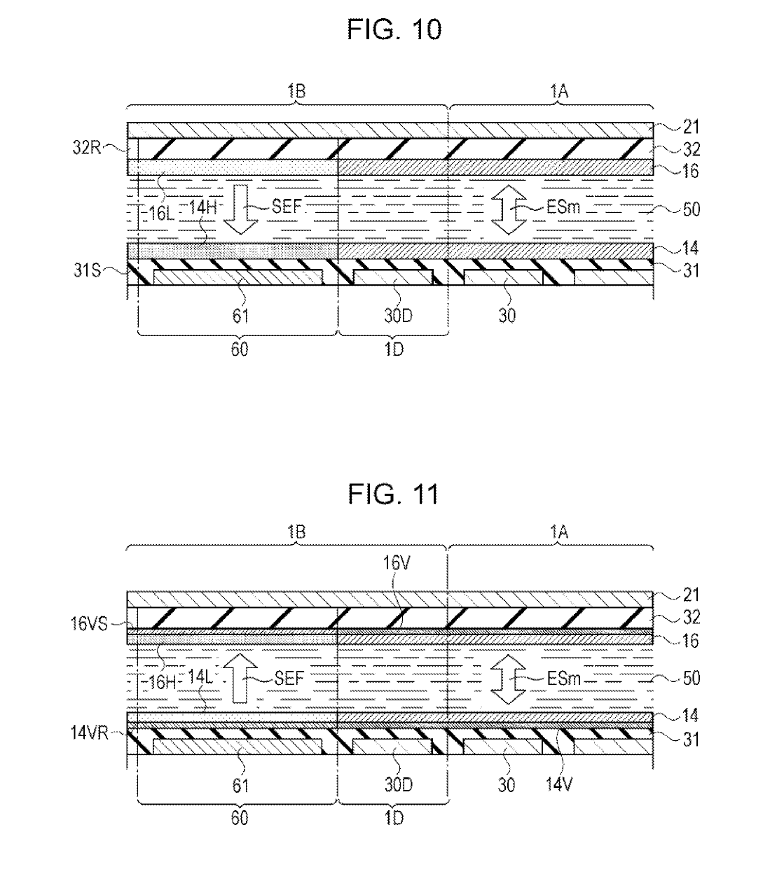

FIG. 10 is a schematic enlarged cross-sectional view of a liquid crystal device. Next, another form in which the third insulation film 31 and the insulation film 32 are different from the embodiment 3 will be described with reference to FIG. 10. In addition, for the same configuration parts as the embodiments 1 to 5, the same symbols are given and redundant description will be omitted.

In the embodiment (FIG. 10), forms of the third insulation film 31 and the insulation film 32 are different from those of the embodiment 4 (FIG. 8). The other configurations are substantially the same as the embodiment 4. Even in such a configuration, the same effects as the embodiment 4 can be obtained. In the embodiments 1 to 4, the manufacturing process may be changed by using the mask evaporation method to make and separate the first orientation film 14 or the second orientation film 16 depending on the region. Meanwhile, in the electro-optical device of the embodiment, as illustrated in FIG. 10, the density of the orientation film is varied by changing the configuration of the electro-optical device. The density of the film of the orientation film is varied by a surface roughness of the underlying film positioned in the lower layer thereof. According to the study of inventors of this application, as the surface of the underlying film is rough, the density of the orientation film formed in the upper layer thereof is decreased. Accordingly, in the embodiment, one of the third insulation film 31 or the insulation film 32, or both the third insulation film 31 and the insulation film 32 are made of a material different from the display region 1A and the peripheral region 1B. As the third insulation film 31 or the insulation film 32 which is the underlying film, the silicon oxide film or the silicon nitride film can be used and it may be used as a passivation film.

As illustrated in FIG. 10, in the ion trap section 60, when the underlying film is a third insulation film 31S having a small surface roughness, the first orientation film 14 formed in the upper layer side thereof is the first orientation film 14H having the high density, and when the underlying film is an insulation film 32R having a large surface roughness, the second orientation film 16 formed in the upper layer thereof is the second orientation film 16L having the low density. Thus, the same configuration as the embodiment 4 is realized, the unusual electric field SEF having a large DC component is formed between the first substrate and the second substrate in the peripheral region 1B, and the ionic impurities present in the liquid crystal material 50 are efficiently captured by being accumulated in the ion trap section 60. As a result, since difference of pre-tilt angle between substrates in the peripheral region 1B is large, the unusual electric field SEF also becomes strong and the positive ionic impurities present in the liquid crystal material 50 are efficiently captured by being accumulated in the vicinity of the peripheral electrode 61 of the ion trap section 60.

### Embodiment 7

### Form 1 Having Two-Layer Orientation Film

FIG. 11 is a schematic enlarged cross-sectional view of a liquid crystal device. Next, a form in which the orientation film has two layers will be described with reference to FIG. 11. In addition, for the same configuration parts as the embodiments 1 to 4, the same symbols are given and redundant description will be omitted.

In the embodiment (FIG. 11), a form of the orientation is different from those of the embodiment 3 (FIG. 7). The other configurations are substantially the same as the embodiment 3. Even in such a configuration, the same effects as the embodiment 3 can be obtained. In the embodiments 1 to 4, the first orientation film 14 or the second orientation film 16 has the film having one layer. Meanwhile, in the electro-optical device of the embodiment, as illustrated in FIG. 11, the orientation film has a two-layer structure. In the orientation film having two layers, the density of the film of the upper layer orientation film is varied by a surface roughness of the lower layer orientation film thereof. According to the study of inventors of this application, as the surface of the lower layer orientation film is rough, the density of the upper layer orientation film formed in the upper layer thereof is decreased. Accordingly, in the embodiment, both the first orientation film 14 and the second orientation film 16 have the two-layer structure, one of the first orientation film 14 and the second orientation film 16, or both the first orientation film 14 and the second orientation film 16 are made of a material different from the display region 1A and the peripheral region 1B. The lower layer orientation film may be a vertical evaporation orientation film and the upper layer orientation film may be an oblique evaporation orientation film.

As illustrated in FIG. 11, the first orientation film 14 in the display region 1A has a first vertical evaporation orientation film 14V in the lower layer thereof and the second orientation film 16 in the display region 1A has a second vertical evaporation orientation film 16V in the lower layer thereof. The first vertical evaporation orientation film 14V and the second vertical evaporation orientation film 16V are made of a homogeneous material. As a result, the first orientation film 14 in the display region 1A and the second orientation film 16 in the display region 1A are made of the homogeneous material having the same density of the film.

In the ion trap section 60 of the first substrate, a first vertical evaporation orientation film 14VR having a large surface roughness is formed on the third insulation film 31 and the first orientation film 14L having the low density is formed on the upper layer thereof. In the ion trap section 60 of the second substrate, a second vertical evaporation orientation film 16VS having a small surface roughness is formed on the insulation film 32 and the second orientation film 16H having the high density is formed on the upper layer thereof. Thus, the same configuration as the embodiment 3 is realized, the unusual electric field SEF having a large DC component is formed between the first substrate and the second substrate in the peripheral region 1B, and the ionic impurities present in the liquid crystal material 50 are efficiently captured by being accumulated in the ion trap section 60. As a result, since difference of pre-tilt angle between substrates in the peripheral region 1B is large, the unusual electric field SEF also becomes strong and the negative ionic impurities present in the liquid crystal material 50 are efficiently captured by being accumulated in the vicinity of the peripheral electrode 61 of the ion trap section 60.

### Embodiment 8

### Form 2 Having Two-Layer Orientation Film

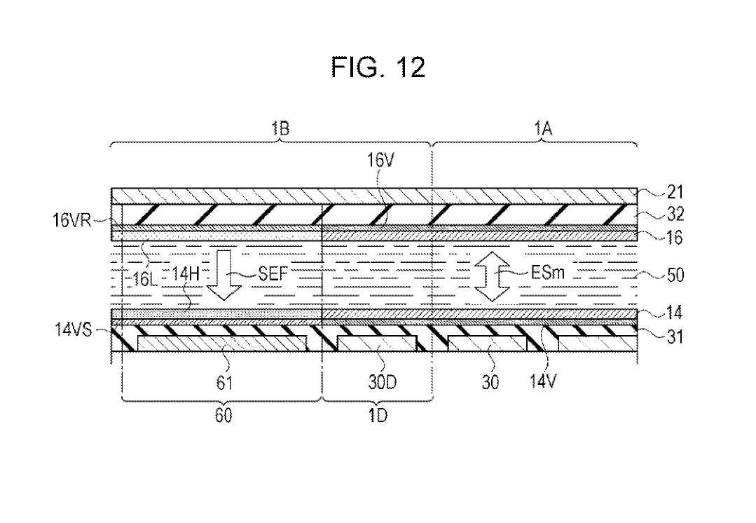

FIG. 12 is a schematic enlarged cross-sectional view of a liquid crystal device. Next, a form in which the orientation film has two layers will be described with reference to FIG. 12. In addition, for the same configuration parts as the embodiments 1 to 4, the same symbols are given and redundant description will be omitted.

In the embodiment (FIG. 12), a form of the orientation is different from those of the embodiment 4 (FIG. 8). The other configurations are substantially the same as the embodiment 4. Even in such a configuration, the same effects as the embodiment 4 can be obtained. In the embodiments 1 to 4, the first orientation film 14 or the second orientation film 16 has the film having one layer. Meanwhile, in the electro-optical device of the embodiment, as illustrated in FIG. 12, the orientation film has a two-layer structure. In the orientation film having two layers, the density of the film of the upper layer orientation film is varied by the surface roughness of the lower layer orientation film. According to the study of inventors of this application, as the surface of the lower layer orientation film is rough, the density of the upper layer orientation film formed in the upper layer thereof is decreased. Accordingly, in the embodiment, the first orientation film 14 and the second orientation film 16 have a two-layer structure, and one of the first orientation film 14 and the second orientation film 16, or both the first orientation film 14 and the second orientation film 16 are made of a material different from the display region 1A and the peripheral region 1B. The lower layer orientation film may be the vertical evaporation orientation film and the upper layer orientation film may be the oblique evaporation orientation film.

As illustrated in FIG. 12, the first orientation film 14 in the display region 1A has the first vertical evaporation orientation film 14V in the lower layer thereof and the second orientation film 16 in the display region 1A has the second vertical evaporation orientation film 16V in the lower layer thereof. The first vertical evaporation orientation film 14V and the second vertical evaporation orientation film 16V are made of a homogeneous material. As a result, the first orientation film 14 in the display region 1A and the second orientation film 16 in the display region 1A are made of the homogeneous material having the same density of the film.

In the ion trap section 60 of the first substrate, the first vertical evaporation orientation film 14VS having a small surface roughness is formed on the third insulation film 31 and the first orientation film 14H having the high density is formed on the upper layer thereof. In the ion trap section 60 of the second substrate, the second vertical evaporation orientation film 16VR having a large surface roughness is formed on the insulation film 32 and the second orientation film 16L having the low density is formed on the upper layer thereof. Thus, the same configuration as the embodiment 4 is realized, the unusual electric field SEF having a large DC component is formed between the first substrate and the second substrate in the peripheral region 1B, and the ionic impurities present in the liquid crystal material 50 are efficiently captured by being accumulated in the ion trap section 60. As a result, since difference of pre-tilt angle between substrates in the peripheral region 1B is large, the unusual electric field SEF also becomes strong and the positive ionic impurities present in the liquid crystal material 50 are efficiently captured by being accumulated in the vicinity of the peripheral electrode 61 of the ion trap section 60.

The invention is not limited to the above embodiments and can be appropriately changed within a range which is not contrary to the gist or spirit of the invention which is read from claims and the entire specification. In addition, an electro-optical device and an electronic apparatus to which the electro-optical device is applied are also included in a technical range of the invention according to such a change. Various modification examples may be provided besides the above embodiments. Hereinafter, modification examples are described.

### Modification Example 1

### Form Having Dummy Electrode Used as Peripheral Electrode

Description will be given with reference to FIG. 1. In the embodiments 1 to 8, as illustrated in FIG. 1, the ion trap section 60 is provided outside the dummy pixels DM. That is, the peripheral electrode 61 is provided outside the dummy electrode 30D. Meanwhile, as described in the modification example, the dummy electrode 30D may be used as the peripheral electrode 61.

Specifically, substantially the entire surface of the peripheral region 1B is covered by the dummy pixels DM in a plan view and the dummy pixels DM hidden in the light shielding film BM are used as the peripheral electrode 61. In this case, it is possible to maintain the electric symmetry ESm between the first substrate and the second substrate in the dummy pixels DM adjacent to the display region and to prevent the temporal degradation of the display quality. On the other hand, the unusual electric field SEF having a large DC component is formed between the first substrate and the second substrate in the dummy pixels DM formed in the ion trap section 60, and the ionic impurities present in the liquid crystal material 50 are efficiently captured by being accumulated in the ion trap section 60. In other words, when the dummy pixels DM are provided in the peripheral region 1B in a plurality of lines, the electric symmetry ESm is maintained between the first substrate and the second substrate in the dummy pixels DM adjacent to the display region 1A similar to the display region 1A and the unusual electric field SEF having a DC component is formed between the first substrate and the second substrate in the dummy pixels DM formed opposite to the display region 1A. It is possible to reduce the influence of the ionic impurities on the display with such a configuration. Furthermore, the first potential is supplied to the dummy pixels DM adjacent to the display region to perform the dark display (black display), and the peripheral electrode signal V11 similar to the embodiment 1 is supplied to the dummy pixels DM formed in the ion trap section 60.

The entire disclosure of Japanese Patent Application No. 2012-267974, filed Dec. 7, 2012 is expressly incorporated by reference herein.

What is claimed is:

1. An electro-optical device comprising:
a pixel electrode provided in a display region;
an electrode provided on the outside of the display region; and
a first orientation film which covers the pixel electrode in the display region and covers the electrode on the outside of the display region,
wherein the densities of the first orientation film are different in the display region and on the outside of the display region.

2. An electro-optical device comprising:
a first substrate; and
a second substrate disposed opposite to the first substrate,
wherein the first substrate includes
a pixel electrode provided in a display region;
an electrode provided on the outside of the display region; and
a first orientation film which covers the pixel electrode in the display region and covers the electrode on the outside of the display region,
wherein the second substrate includes
a common electrode disposed so as to overlap the pixel electrode and the electrode, respectively; and
a second orientation film which covers the common electrode, and
wherein the densities of the second orientation film are different in the display region and on the outside of the display region.

3. The electro-optical device according to claim 2,
wherein the density of the first orientation film formed on the outside of the display region is different from the density of the second orientation film formed on the outside of the display region.

4. The electro-optical device according to claim 3,
wherein the density of the first orientation film formed in the display region is substantially the same as the density of the second orientation film formed in the display region.

5. The electro-optical device according to claim 1, further comprising:
a common electrode disposed so as to overlap the pixel electrode and the electrode, respectively; and
a second orientation film which covers the common electrode,
wherein the density of the first orientation film formed in the display region, the density of the second orientation film formed in the display region and the density of the second orientation film formed on the outside of the display region are substantially the same as each other.

6. The electro-optical device according to claim 2,
wherein the density of the first orientation film formed in the display region, the density of the second orientation film formed in the display region and the density of the first orientation film formed on the outside of the display region are substantially the same as each other.

7. The electro-optical device according to claim 2,
wherein the density of the first orientation film formed in the display region is substantially the same as the density of the second orientation film formed in the display region,
wherein the density of the first orientation film formed on the outside of the display region is different from the density of the second orientation film formed on the outside of the display region, and
wherein the density of the first orientation film formed in the display region is different from the density of the first orientation film formed on the outside of the display region.

8. An electronic apparatus comprising:
the electro-optical device according to claim 1.
